(19) United States
(12) Patent Application Publication
(10) Pub. No.: US 2017/0225503 A1
(43) Pub. Date: Aug. 10, 2017

(54) SECURITY PAPERS AND DOCUMENTS

(71) Applicant: DE LA RUE INTERNATIONAL LIMITED, Hampshire (GB)

(72) Inventors: Peter McLean Henderson, Somerset (GB); Matthew Charles Sudgon, Hampshire (GB); Georgina Stewart, Hampshire (GB)

(73) Assignee: DE LA RUE INTERNATIONAL LIMITED, Hampshire (GB)

(21) Appl. No.: 15/493,742

(22) Filed: Apr. 21, 2017

Related U.S. Application Data
(63) Continuation of application No. PCT/GB2015/053144, filed on Oct. 21, 2015.

(30) Foreign Application Priority Data
Oct. 23, 2014 (GB) 1418856.9

(51) Int. Cl. B42D 25/333; B42D 25/23; B42D 25/378; B42D 25/47; B42D 25/355; B42D 25/328; B42D 25/425; B42D 25/24; B42D 25/351

(52) U.S. Cl. CPC B42D 25/333; B42D 25/24; B42D 25/23; B42D 25/378; B42D 25/351; B42D 25/355; B42D 25/328; B42D 25/425; B42D 25/47

(57) ABSTRACT

A security paper is provided that includes at least one layer of fibrous substrate and a security deposit thereon. The at least one layer has a main body of a substantially uniform thickness and at least one aperture and/or zone of reduced thickness. The reduced thickness is non-zero and at least 15% less than the thickness of the main body. The security deposit includes at least one element that partially covers the fibrous substrate exposed in the at least one aperture and/or zone of reduced thickness. Therefore, when the at least one layer is split through its thickness into first and second portions, a hole is provided in the first portion and the at least one element is provided on the fibrous substrate of the second portion. A method of manufacturing the security paper and security documents including the security paper are also provided.

### CROSS REFERENCE TO RELATED APPLICATIONS

This application is a continuation of International Application No. PCT/GB2015/053144 filed on Oct. 21, 2015, which claims the benefit of British Application No. GB 1 418 856.9 filed on Oct. 23, 2014, the entire contents of both of which are incorporated by reference herein.

### BACKGROUND

1. Field of the Invention

The present invention is directed towards security paper comprising at least one fibrous substrate layer having a plurality of apertures and/or zones of reduced thickness and a security deposit at least partially overlapping said apertures and/or zones. The invention further relates to a method of manufacturing said security paper and security documents comprising said security paper.

2. Description of Related Art

Security documents and booklets such as passports, passbooks, identification documents, certificates, licences and cheque books commonly comprise one or more data pages on which information is provided. For example, as disclosed in WO-A-2010/040987, a passport booklet typically comprises a cover (having a front and a back) and a plurality of internal pages (sometimes known as visa pages) therebetween. Typically the visa pages are made from paper having a grammage of around 85 gsm and are sewn together. The cover is adhered to the outside of the visa pages and thereby protecting the stitch line. An RFID chip or similar device can be provided within the cover for electronic detection and further security.

At least one data page is provided integrally with one of the visa pages, usually sewn into the stitch line and/or as part of the cover. The data pages commonly comprise one or more base layers of a fibrous substrate, such as paper, overlaid by a layer of polymer laminate, usually applied as a film or lacquer. The fibrous substrate layers are usually made, for example, from paper or cotton fibres and usually have a grammage of around 110 gsm.

The base layer typically has a number of security features, such as watermarks and machine readable printing. In particular, cylinder mould or electrotype watermarks may be formed in the fibrous substrate during manufacture. Personalised information relating to the owner of the security document, such as their name, address, nationality, date of birth and photograph, may be subsequently printed onto the base layer before the laminate layer is applied.

The laminate layer usually has one or more further security features, such as holograms, colour changing inks or other optically variable elements. Holograms can be provided in alignment with the personalised information and/or security features of the base layer. For example, the laminate layer may be arranged to make a watermark in the base layer visible only when viewed from certain angles. The laminate layer is attached to the fibrous substrate by an adhesive, which prevents the removal of the laminate layer without destroying the personalised information printed on the base layer.

However, it has been found that counterfeiters are able to manufacture counterfeit security documents from original security documents by splitting the base layer through the plane of the ply. This enables the laminate layer and personalised information to be separated from the part of the base layer containing one or more security elements, such as a watermark. The counterfeiter can print new personalised information on this part of the base layer and then apply a new laminate layer containing reproduced security features within it. As a result, the reproduced data page will include a base layer having some of the security features of the original base layer.

WO-A-2011/110799 addresses the problem of counterfeiters splitting banknotes in two along the plane of the note and subsequently forming a counterfeited banknote comprising the front of the genuine note adhered to the back of a counterfeit note. In WO-A-2011/110799 a security substrate is provided with two sets of regions, one set being located on either surface of the substrate, and both of which are required to be present to form a machine readable code. If the banknote is split, the machine readable code will not be formed and the counterfeit can be recognised. However, such an arrangement is not suitable in security documents not having a machine readable code and/or not having the sets of regions on both sides of the security substrate. This is particularly the case for passports, although is also applicable to other security documents.

WO-A-2011/015798 discloses a laminate document having first and second layers which are not designed to be separated in use. A first layer is perforated with apertures by a laser, mechanical or drilling technique and after lamination of the layers the apertures are printed with ink. The ink forms an image on the face surface of the first layer, is deposited on the internal surfaces of the apertures and forms inked regions on the second layer. If the second layer is replaced it is difficult for a counterfeiter to achieve the correct alignment between the apertures and inked regions.

### SUMMARY

An object of the present invention is to improve the security of security documents by preventing adaptation by counterfeiters, whether by splitting or other means, and by improving the ability of any such adaption to be recognised by a machine or eye.

The present invention therefore provides a security paper comprising: at least one layer of fibrous substrate having a main body of a substantially uniform thickness and at least one aperture and/or zone of reduced thickness, said reduced thickness being at least 15% less than the thickness of the main body; and a security deposit at least partially overlapping the at least one aperture and/or zone of reduced thickness such that, when the at least one layer is split through its thickness into first and second portions, a hole is provided in the first portion and the overlapping security deposit is provided on the second portion.

In a preferred embodiment the reduced thickness is at least 25% less than the thickness of the main body.

The security deposit preferably forms shapes, patterns and/or other indicia and is visible to the naked eye or machine readable. The security paper may comprise a plurality of regions or elements of the security deposit wherein at least two regions or elements are disposed within the at least one aperture and/or zone of reduced thickness. In preferred embodiments the security deposit is an ink.

The at least one layer preferably forms first and second surfaces of the security paper, the security deposit being located on the first surface and being visible in reflected light incident upon the second surface through the at least one aperture and/or zone of reduced thickness. In a particular embodiment the security paper comprises first and second layers of fibrous substrate, the at least one aperture and/or zone of reduced thickness being formed in the first layer.

In a further preferred embodiment the at least one layer forms first and second surfaces of the security paper; the security deposit is located on the first surface; and a security illuminate is provided on the second surface and overlaps the at least one aperture and/or zone of reduced thickness, said security illuminate being visible through the at least one aperture and/or zone of reduced thickness in reflected light incident upon the first surface.

The invention further provides a security document comprising the security paper of the present invention. The security document is preferably a document of value such as a banknote, a cheque, a certificate, a passport, a passport page, an identification card and a drivers licence.

In a preferred embodiment of the security document a transparent or semi-transparent protective layer is provided over the at least one aperture and/or zone of reduced thickness and security deposit. The protective layer is preferably arranged such that when the at least one layer is split through its thickness into first and second portions, a hole is provided in the first portion through the protective layer and the overlapping security deposit and protective layer are provided on the second portion.

In yet a further preferred embodiment of the security document the security deposit at least partially forms personalised information relating to the owner of the security document.

The reduced thickness is preferably non-zero. Preferably the security deposit comprises at least one element which partially covers the fibrous substrate exposed in the at least one aperture and/or zone of reduced thickness such that, when the at least one layer is split through its thickness into first and second portions, a hole is provided in the first portion and the at least one element is provided on the fibrous substrate of the second portion. As a result, it is not possible for a counterfeiter to use the at least one aperture and/or zone of reduced thickness as a mask to reproduce the at least one element.

Preferably the at least one element which partially covers the fibrous substrate exposed in the at least one aperture and/or zone of reduced thickness is separated from the edge of the at least one aperture and/or zone of reduced thickness. Preferably the at least one element forms data which is visually recognisable to a user or machine readable both before and after splitting the at least one layer. Preferably the at least one element is in the shape of a letter or character which forms part of personalised data. As a result, a counterfeiter needs to accurately reproduce both the at least one aperture and/or zone of reduced thickness and the at least one element. Thus, in the case of a security paper comprising first and second layers, the counterfeiter needs to reproduce both layers. In WO-A-2011/015798 just one of the first and second layers needs to be reproduced.

Preferably the at least one aperture and/or zone of reduced thickness is formed during the formation of the at least one layer of fibrous substrate from a fibrous stock using controlled drainage zones. An aperture and/or zone of reduced thickness formed during papermaking will typically have different physical characteristics from those of a window feature or aperture formed in the substrate after its formation, e.g. by cutting, stamping or abrasion, and can thus be distinguished from such apertures by inspection. For example, a window feature such as an aperture and/or zone of reduced thickness formed during formation of the layer of fibrous substrate will typically have irregular edges which expose individual fibres or bunches of fibres, and/or a finite region surrounding the aperture and/or zone of reduced thickness in which the fibre density of the fibrous substrate is lower than that of the main body of the layer of fibrous substrate. The detailed shape of the periphery of the aperture and/or zone of reduced thickness will generally also change from one document to the next, since this is determined to an extent by the arrangement of fibres, which will be random. In contrast, the edges of an aperture or window feature formed after papermaking will typically be well-defined and generally closely follow a pre-determined shape, such as a circle.

In a particular embodiment the present invention is directed to a security paper comprising: first and second layers of fibrous substrate, the first layer having a main body of a substantially uniform thickness and at least one aperture, the second layer being exposed through the at least one aperture; and a security deposit comprising at least one element which partially covers the second layer exposed in the at least one aperture such that, when the first and/or second layers are split through their thickness into first and second portions, a hole is provided in the first portion and the at least one element is provided on the second layer in the second portion.

In yet a further particular embodiment the present invention provides a security paper comprising: a layer of fibrous substrate having a main body of a substantially uniform thickness and at least one zone of reduced thickness, said reduced thickness being non-zero at least 15% less than the thickness of the main body; and a security deposit comprising at least one element which partially covers the zone of reduced thickness such that, when the layer is split through its thickness into first and second portions, a hole is provided in the first portion and the at least one element is provided on the second portion.

The invention further provides a method of manufacturing a security paper comprising the steps of: depositing fibres from a vat of aqueous stock on a support surface to form a fibrous substrate and restricting drainage through the support surface at controlled drainage zones to form at least one layer of fibrous substrate having a main body of a substantially uniform thickness and at least one aperture and/or zone of reduced thickness, said reduced thickness being at least 15% less than the thickness of the main body; couching the layer of fibrous substrate from the support surface; drying the layer of fibrous substrate; and providing a security deposit on the layer of fibrous substrate to at least partially overlap the at least one aperture and/or zone of reduced thickness, such that when the at least one layer is split through its thickness into first and second portions, a hole is provided in the first portion and the overlapping security deposit is provided on the second portion.

The method preferably further comprises the step of, before the drying step, combining the layer of fibrous substrate with a second layer of fibrous substrate, said second layer of fibrous substrate being formed in a separate forming step. In preferred embodiments the controlled drainage zones are formed from at least one of a blinding material affixed to the support surface, an electrotype affixed to the support surface and embossed regions in the support surface.

The security deposit provision step preferably further comprises: (a) identifying the at least one zone and/or aperture; (b) calculating the position of the at least one zone and/or aperture in the fibrous substrate layer; and (c) depositing the security deposit in a predetermined position relative to the at least one zone and/or aperture.

The method preferably comprises the step of, after depositing the security deposit, applying a transparent or semi-transparent protective layer over the at least one aperture and/or zone of reduced thickness and security deposit. Preferably during the application of the protective layer an adhesive and/or lacquer is pressed into a region underneath the surface of the fibrous substrate.

### BRIEF DESCRIPTION OF THE DRAWINGS

By way of example only, embodiments of a security paper, its method of manufacture and a security document incorporating the security paper are now described with reference to, and as show in, the accompanying drawings, in which:

FIG. 1 is a perspective view of a security paper of the present invention;

FIG. 2 is a cross-sectional side elevation of the security paper of FIG. 1 through section A-A;

FIG. 3 is a cross-sectional side elevation of a portion of the security paper of FIG. 1 after splitting along a split plane;

FIG. 4 is a plan view of a security document of the present invention;

FIG. 5A is a plan view of the top of a security paper of the present invention;

FIG. 5B is a plan view of the underside of the security paper of FIG. 5A;

FIG. 6 is a cross-sectional side elevation of a section of a paper-making machine for use in a method of manufacturing the security paper of FIG. 1;

FIG. 7 is a perspective view of a further embodiment a security paper of the present invention;

FIG. 8 is a cross-sectional side elevation of the security paper of FIG. 7 through section B-B; and

FIG. 9 is a cross-sectional side elevation of a portion of the security paper of FIG. 7 after splitting along a split plane.

### DETAILED DESCRIPTION

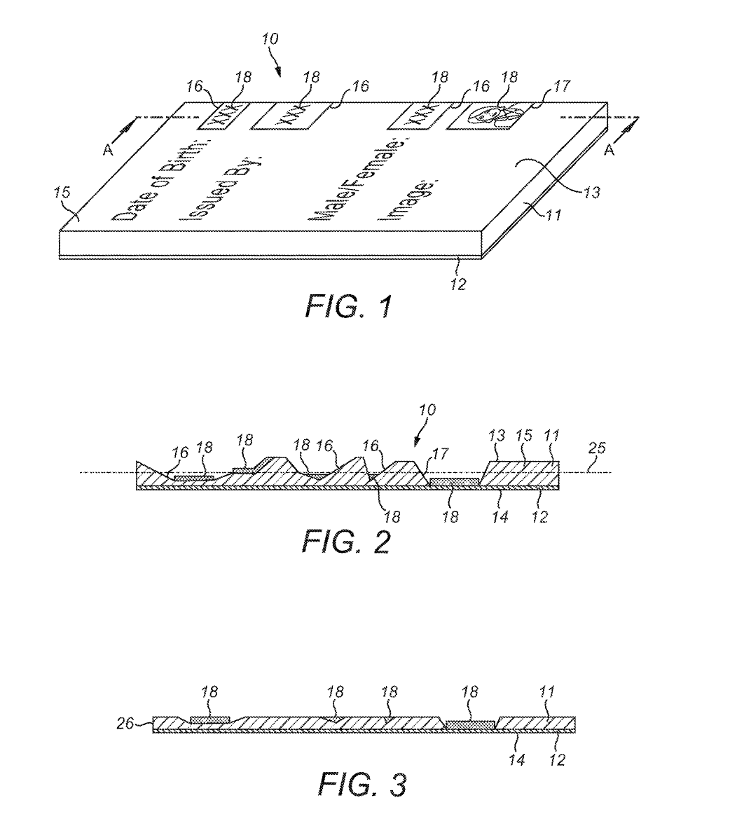

FIGS. 1 to 3 illustrate a first embodiment of a security paper 10 of the present invention. The security paper 10 is preferably two-ply and comprises first and second layers 11, 12 of fibrous substrate. The first surface 13 of the security paper 10 is therefore formed by a surface of the first layer 11, and the second surface 14 of the security paper 10 is formed by a surface of the second layer 12.

The first layer 11 comprises a main body 15 of a substantially uniform or similar thickness. The main body 15 preferably has a grammage of approximately 40 to 150 gsm and more preferably 60 to 120 gsm. The main body 15 preferably forms at least 50% of the surface area of the first layer 11, more preferably at least 75% of the surface area of the first layer 11 and more preferably at least 90% of the surface area of the first layer 11.

The first layer 11 further comprises at least one zone 16 having a reduced thickness, which is may be non-zero and less than the uniform thickness of the main body 15. The reduced thickness of the at least one zone 16 is preferably at least 15% less than the thickness of the main body 15, and more preferably at least 25% less than the thickness of the main body 15. For example, the at least one zone 16 may have a grammage of 30 gsm. The zone 16 further preferably has a uniform thickness and is surrounded by the main body 15 of the larger uniform thickness. The term “thickness” is to be interpreted within the meaning well known in the art, i.e. the dimension of the first layer 11 between its major surfaces. The reduced thickness zone(s) 16 may form up to 50% of the area of the first surface 13 of the security paper 10, more preferably up to 25% of the area of the first surface 13 of the security paper 10 and yet more preferably up to 10% of the area of the first surface 13 of the security paper 10. One or more of the zones 16 may have a zero thickness such that the first layer 11 has one or more apertures 17 through its entire thickness.

Furthermore, the first layer 11 may also comprise one or more security features, although the security features may not be provided in the at least one zone 16 of reduced thickness and/or apertures 17 as they form individual, self-contained security features. One such security feature is a cylinder mould watermark, in which some regions of the watermark are more dense, or thicker, than the uniform thickness of the main body 15 and/or some regions of the watermarks are less dense, or thinner, than the uniform thickness of the main body 15. Another security feature is an electrotype watermark, in which some regions of the electrotype watermark are less dense than the uniform thickness of the main body 15.

In a preferred embodiment the at least one zone 16 of reduced thickness or aperture 17 forms part of a larger watermark. In particular, a zone 16 of reduced thickness could form part of a watermark image, for example the hair of a watermark illustrating a portrait of a person. The aperture 17 may form part of a larger image generated in combination with other watermarks which will have both regions of increased and reduced thicknesses.

Security threads and patches are another suitable security feature which may be applied to first layer 11 or embedded therein in any known manner. For example, a security thread or patch may be applied to a surface of the first layer 11, partially embedded therein, fully embedded therein and/or is exposed at windows in the first surface 13. As a further alternative the security feature may comprise a plurality of security fibres disposed within the first layer 11 and visible in reflected light on the first surface 13.

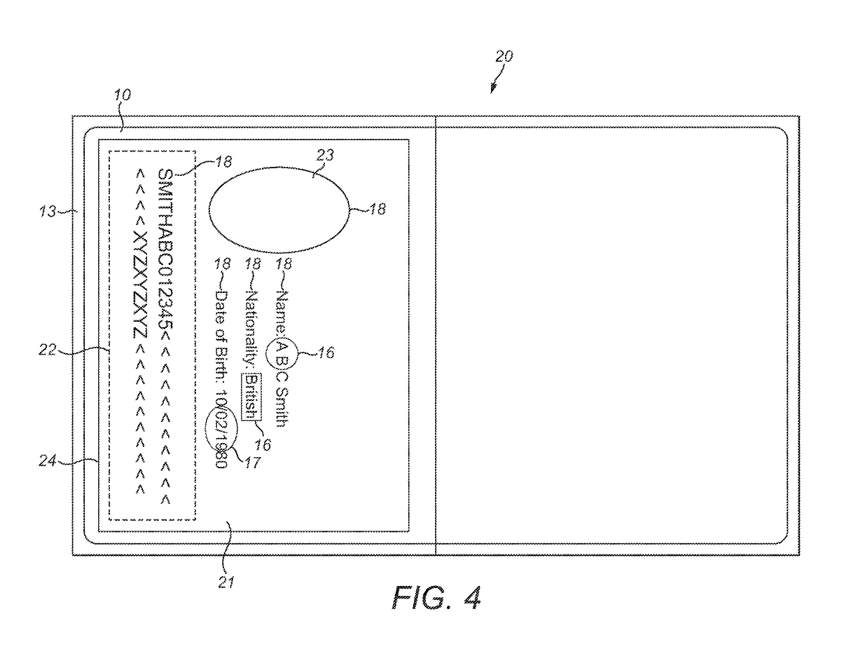

A security deposit 18 is provided in one or more regions or elements on the first surface 13 of the first layer 11, preferably in the form of printed ink (although other embodiments will be described below). The security deposit 18 preferably forms one or more shapes, patterns, or other indicia visually recognisable to a user or machine readable. For example, the security deposit 18 may form a logo, picture, code, letters, numbers, symbols and/or other such elements. The security paper 10 may be used to form a security document 20, for example illustrated in FIG. 4 as a personalised data page of a passport. In this example the security deposit 18 is provided in the form of personal data 21 and/or one or more machine readable zones 22. The personal data 21 can comprise any suitable data relating to the owner of the security document 20, such as their name, address, nationality, date of birth, photograph 23 and/or additional biometric information. The machine readable zone 22 preferably comprises letters, numbers and/or other symbols, which can be scanned and processed using optical recognition to retrieve (possibly coded) data.

As is illustrated in FIGS. 1 and 4, the security deposit 18 at least partially overlaps (i.e. overlies) the at least one zone 16 of reduced thickness and/or aperture 17. Thus, as is best shown in FIG. 2, the security deposit 18 is provided in the thinner zones 16 and at an aperture 17 the security deposit 18 will pass through the first layer 11 and deposit on the second layer 12 such that it is visible through the aperture 17.

Each zone 16 and/or aperture 17 may be only partially covered with the security deposit 18. In particular, only one or two elements, such as one or two letters or symbols, of the personal data 21 may be provided in each zone 16 and/or aperture 17. The personal data 21 in the zone 16 and/or aperture 17 may only be recognisable to a user or machine when combined with the personal data 21 provided on the main body 15 of the security page 10. Furthermore, elements or indicia (such as individual letters or numbers) may be partially formed in a zone 16 and/or aperture 17 and partially on the main body 15. The security deposit 18 may also be provided over the entire area of a zone 16 and/or aperture 17.

Each zone 16 and/or aperture 17 may be provided in any suitable shape, for example, as illustrated in FIG. 4, in the form of simple shapes, such as circles, ovals or squares. In the case of there being a plurality of zones 16 and/or apertures 17, they may all be identically shaped. Alternatively, one or more zones 16 and/or apertures 17 may be shaped to convey recognisable information, such as in the form of symbols, words, codes, numbers or the like. In a particular example a zone 16 or aperture 17 may be provided in the geographical shape of the country to which the security document 20 is related. In particular, one or more zones and/or apertures 17 may be shaped to match the outline or perimeter of the shape of the security deposit 18. For example, the security deposit 18 may display a logo relating to the issuing authority of the security document 20 and the zone 16 or aperture 17 may be provided in the outline of said logo.

Each zone 16 and/or aperture 17 may be dispersed at a random location in the first surface 13 of the security paper 10 and, if there is a plurality of zones 16 and/or apertures 17, they may have no recognisable registration in their relative locations. The security deposit 18 may be provided to match the random locations, or each zone and/or aperture 17 may be disposed randomly within a restricted area of the first surface 13 and the security deposit 18 is provided within that restricted area, such that any two security papers 10 may not contain the same overlap between the zone 16 and/or aperture and security deposit 18.

However, in a preferred embodiment of the invention, at least one zone 16 and/or aperture 17 is provided in a predetermined location in the security paper 10 such that an inspector of the document can detect when they are not provided in the correct place. In preferred embodiments the position of the at least one zone 16 and/or aperture 17 is detectable by a machine such that, during manufacture, the security deposit 18 can be provided in a predetermined positional relationship to the at least one zone 16 and/or aperture 17. This registration between the two features makes the security paper 10 harder to reproduce by a counterfeiter as they will not only need to reproduce both the at least one zone 16 and/or aperture 17 and security deposit 18, but will also need to ensure that they are correctly positioned relative to one another.

The second layer 12 is preferably of a substantially uniform thickness and is preferably relatively thin (i.e. substantially thinner than the first layer 11), for example having a grammage of approximately 10 to 50 gsm and more preferably of approximately 15 to 30 gsm. The second layer 12 may also be provided with one or more security features such as a cylinder mould watermark, an electrotype watermark, security threads, security patches and security fibres. Printing may also be applied to the second surface 14 formed by the second layer 12 using any known printing techniques, such as dye-sublimation, screen, flexography, lithography, intaglio, gravure, dye diffusion, laser, inkjet toner, letterpress and toner transfer.

The security document 20, particularly if it is a passport, may further comprise a protective layer 24 attached to the first surface 13 of the security paper 10 over the personal data 21 and machine readable zone 22. The protective layer 24, typically approximately 10 μm thick and transparent or semi-transparent, may comprise a lacquer layer or polymeric film, the application of which will be described in further detail below. Preferably, the protective layer 24 includes one or more security features, such as holograms, colour changing inks or other optically variable elements to make it more difficult to reproduce by a counterfeiter. The security features may be applied using a transfer layer such that they are provided underneath the protective layer 24. Thus the protective layer 24 protects against wear of the security paper 10 as well as providing a security function to the security document 20.

The security document 20 may further comprise an identification feature embedded within, or on, the first and/or second layer 11, 12. The identification feature may be of any type suitable for storing data relating to the document, such as personalisation data relating to the owner of the document or bibliographic data, which can be electronically read by a computer processor and suitable transmitter and/or receiver. In particular, the identification feature is an RFID chip or NFC tag. In the case of a passport, identity document or the like in which the security document 20 relates to the identity of the owner the identification feature stores biometric data relating to the owner, such as iris information, fingerprint information or face recognition data.

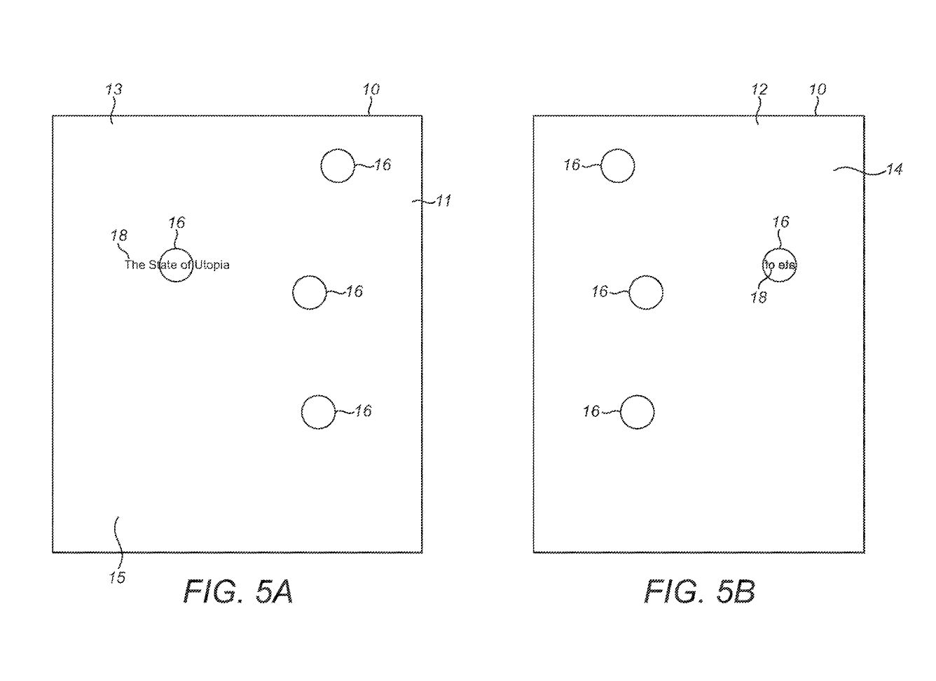

The security deposit 18 is visible in reflected light incident upon the first surface 13, i.e. when the security paper 10 is viewed from the same side of the security paper 10 as a light source. If the thickness of the security paper 10 at the zones 16 and/or 17 is sufficiently small, they may also be visible in reflected light (particularly at their edges) incident on the first surface 13. Furthermore, if the security deposit 18 is sufficiently opaque and, if the thickness of the security paper 10 at the zones 16 and/or apertures 17 is sufficiently small, the security deposit 18 on the first surface 13 will be visible in reflected light incident upon the second surface 14. The zones 16 and/or apertures 17 will be visible in transmitted light, i.e. when the security paper 10 is viewed from the opposing side of the security paper 10 to a light source. The security deposit 18 will also be visible through the zones 16 and/or apertures 17 when the second surface 14 is viewed in transmitted light, as illustrated by in FIGS. 5A and 5B.

The security function of the present invention is best illustrated with reference to FIGS. 2 and 3. Typically a counterfeiter would attempt to adapt the security document 20 such that the personalised information 21 and machine readable code 22 relates to a different person other than the original owner of the security document 20, but retain the security features (particularly the identification feature) provided in the first and/or second layers 11, 12 to avoid detection. To do so, they would attempt to split the security paper 10, along a split plane 25 between the first and second surfaces 13, 14, into a first portion (not shown in FIG. 3) and a second portion 26. The first portion, which includes the first surface 13, at least part of the first layer 11 and any security deposit 18 thereon, is discarded by the counterfeiter. The counterfeiter would then attempt to reuse the second portion 26, which includes the second surface 14 and at least part of the first and/or second layers 11, 12, by applying new security deposit 18 thereon.

The split plane 25 is a plane of failure inherent within layers of fibrous substrate of at least 40 gsm and above. Typically the split plane 25 is towards the centre of a layer of fibrous substrate (i.e. midway between its surfaces) and is substantially parallel to the opposing surfaces of the layer. Therefore, as illustrated in FIG. 2, particularly where the second layer 12 is thinner than the first layer 11, the split plane 25 will tend to be towards the centre of the first layer 11.

In the present invention the second portion 26 formed after the splitting of the security paper 10 will still include at least some of the security deposit 18. This is because, during splitting of the security paper 10, the zones 16 of reduced thickness will break apart from the first layer 11 and remain coupled to the second layer 12. Any security deposit 18 overlapping the zones 16 will therefore remain on the second portion 26. Any security deposit 18 provided on the second layer 12 through the apertures 17 in the first layer 11 will also still be present on the second portion 16. In addition, portions of any protective layer 24 provided over the first surface 13 may also be left attached to the second portion 26 in the zones 16 and/or apertures 17. However, if the protective layer 24 is sufficiently thick, it will not be separated during the splitting of the security paper 10 and would remain attached to the first portion (the security deposit 18 would still remain attached to the second portion 26).

Therefore, a counterfeiter would not be able to effectively reuse the second portion 26 to form a new counterfeit security document since, if it were reused, the counterfeit security document could be readily identified by virtue of the presence of the security deposit 18 and possibly protective layer 24 remaining on the second portion 26. In addition, any remaining protective layer 24 would significantly disrupt the printing of ink or the like on top of the second portion 26.

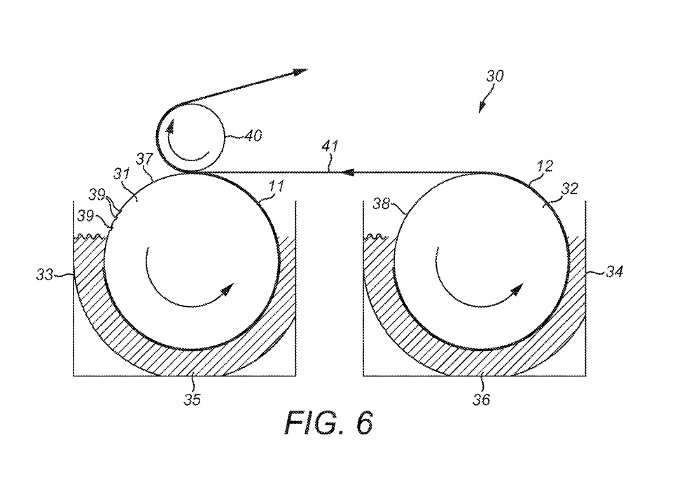

FIG. 6 illustrates a section of a cylinder mould papermaking machine 30 suitable for use in the manufacture of the security paper 10 of the first embodiment of the present invention. The machine 30 comprises first and second cylinder moulds 31, 32 rotating in first and second vats 33, 34 of aqueous fibrous stock 35, 36. The cylinder moulds 31, 32 are covered with porous support surfaces, such as porous wire meshes, which form first and second cylinder mould covers 37, 38.

The fibrous stock 35, 36 may comprise a range of fibre types, including synthetic or natural fibres, or a mixture of both. The actual preparation of the fibres is unrestricted by the invention, and will depend upon the effect desired in the fibrous substrate layers 11, 12. As a general consideration, security paper 10 used for security documents, such as banknotes, passports, identification cards and so on, needs to be hard wearing, resilient, and self-supporting, and so an appropriate fibre mix is preferably selected.

As the cylinder moulds 31, 32 rotate the liquid within the fibrous stock 35, 36 passes through the porous support surfaces of the cylinder mould covers 37, 38. The fibres are deposited on the support surfaces and the first and second layers 11, 12 are thereby formed, the first layer 11 being formed on the first cylinder mould 31 and the second layer 12 being formed on the second cylinder mould 32. The arrangement for forming the second layer 12 is known in the art as a “short former”. As previously discussed herein, the first fibrous substrate layer has a grammage of around 90 gsm and the second fibrous substrate layer has a grammage of around 20 gsm.

Controlled drainage zones 39 are formed on the first cylinder mould cover 37 for forming the zones 16 of reduced thickness and/or apertures 17 in the first layer 11. The shape of the controlled drainage zones 39 is selected to correspond to the desired shape of the zones 16 and/or apertures 17 in the security paper 10. There may be a plurality of controlled drainage zones 29 provided around the first cylinder mould cover 37.

As the cylinder mould 31 rotates, the liquid from the fibrous stock 35 passes through the porous support surface and the fibres are deposited on the first cylinder mould cover 37. Due to the controlled drainage zones 39, little or no covering of fibres is provided on them. Some fibres may form on the controlled drainage zones 39, but the substrate cannot properly form thereon as insufficient fibres will deposit. If necessary, any such unwanted fibres can be removed during subsequent processing steps. Therefore, the first layer 11 will be formed with zones 16 of reduced thickness and/or apertures 17 corresponding to the controlled drainage zones 39.

The controlled drainage zones 39 may be formed by fixing a blinding material to the first cylinder mould cover 37, for example by welding a metal thereto. Alternative materials include wax, polymer or another material which can be securely attached to the first cylinder mould cover 37 to prevent drainage of liquid from the fibrous stock 35 and hence fibre deposition. Similar arrangements are disclosed in WO-A-00/39391 and WO-A-2004/001130, the contents of which are incorporated herein by reference. Such methods are particularly suited to forming the apertures 17 or zones 16 with very low thicknesses. In order to prevent the deposition of fibres to form apertures 17 the blinding material may be sufficiently large to prevent fibres from bridging it and/or it may be substantially impervious to the fluid carrying the fibres in the fibrous stock 35. For example, the blinding material may be formed of a polymer resin, metal or ceramic body. If some deposition of fibres is required to form zones 16 of very low thickness the blinding material may be just narrow enough that fibres can bridge it and may be made slightly impervious (but still not as impervious as the first cylinder mould cover 37). For example, the blinding material may be formed of a perforated metal or polymer member.

Alternatively, or in addition, the controlled drainage zones 39 may be formed by electrotypes having regions of a relatively large height. Electrotypes, as is well-known and has been described in, for example, U.S. Pat. No. 1,901,049 and U.S. Pat. No. 2,009,185, are provided in the form of thin pieces of metal, attached to the first cylinder mould cover 37, having raised regions. The electrotypes comprise regions of relatively large height (i.e. extending away from the first cylinder mould cover 37) which cause areas of little or no fibre deposition, thereby forming the apertures 17 or zones 16 of reduced thickness. As previously discussed, the apertures 17 and/or zones 16 may form part of a larger, electrotype watermark and are formed by part of an electrotype forming a larger image.

In yet a further arrangement, the controlled drainage zones 39 may be formed using embossed regions in the first cylinder mould cover 37, in manner similar to the process used to produce cylinder mould watermarks (and, indeed, the apertures 17 and/or zones 16 may form part of such a watermark). The embossed regions may comprise areas of substantial height difference, which create areas of little or no fibre deposition to form the apertures 17 or zones 16 of reduced thickness.

During the formation of the first and second layers 11, 12, various techniques may be employed to include the aforementioned security features therein using any suitable method known in the art. For example, the first and/or second cylinder mould covers 37, 38 may additionally comprise embossed regions to form cylinder mould watermarks in the security paper 10 separate from the zones 16 and/or apertures 17. Electrotypes can also be used to form electrotype watermarks (i.e. light tonal regions) in the first and/or second layers 11, 12 separately from the zones 16 and/or apertures 17. A security thread may also be embedded in (wholly or partially) the fibrous substrate as it forms on the first and/or second cylinder mould cover 37, 38. Security fibres may be injected into fibrous stock 35, 36 adjacent to the first and/or second cylinder mould covers 37, 38 such that they are embedded within the first and/or second layer 11, 12. Any of the techniques disclosed in WO-A-00/39391, WO-A-2004/001130, U.S. Pat. No. 1,901,049, U.S. Pat. No. 2,009,185 and EP-A-059056 may be employed to incorporate the security features in the first and/or second layers 11, 12.

As the first and second layers 11, 12 are formed, they are couched from the first and second cylinder mould covers 37, 38 as a continuous web, for example by a couch roll 40 for the first layer 11 and a felt 41 for the second layer 12. The couch roll 40 rotates in contact with the first cylinder mould cover 31 and is used to transfer the first layer 11 from the first cylinder mould cover 31 to the felt 41 (formex) which carries the web from the wet end of the papermaking machine 30 to a press section (not shown in the drawings). The felt 41 feeds the second layer 12 into the first layer 11 at the point where the first layer 11 is couched from the first cylinder mould 31 onto the couch roll 40. The first and second layers 11, 12 are thereby combined to form a single ply prior to drying.

Water is extracted from the wet fibrous web and the web of paper undergoes a drying process. The dried web may then be cut along cutting lines to form a plurality of interim sheets, which are stacked in reams of typically 500 sheets. Preferably the dried security paper 10 has a grammage of in the range of approximately 70 to 180 gsm and more preferably in the range of approximately 90 to 150 gsm.

The security deposit 18 is applied to the first and second layers 11, 12, before or after the cutting process, such that it at least partially overlaps the at least one zones 16 of reduced thickness and/or aperture 17. In particular, a portion of the security deposit 18 containing non-variable information (such as the words “Name”, “Date of Birth” etc illustrated in FIGS. 1 and 4) may be applied before cutting and a portion of the security deposit 18 containing variable or personalised information (such as the name or date of birth of the owner of the security document 20) may be applied after cutting.

The aforementioned registerability of the zones 16 and/or apertures 17 may be particularly suitable for the application of the latter security deposit 18, since the application machine can determine where the security deposit 18 needs to be applied by registration with the zones 16 and/or apertures 17. A suitable application machine is disclosed in WO-A-2009/037414, the contents of which are incorporated herein by reference. In broad terms, the application machine initially identifies the at least one zone 16 and/or aperture 17, calculates its position on the security paper 10 (for example by determining the position of an edge or centre of a zone 16 or aperture 17) and subsequently applies the security deposit 18 in a predetermined position relative to the at least one zone 16 and/or aperture 17.

The security deposit 18 is formed of any suitable dispersed mass which can be easily separated when the security paper 10 is split such that some security deposit 18 remains on the second portion 26 discussed above. Preferably the security deposit 18 is an ink, but may comprise any other suitable composition which includes an identifiable property. For example, optically variable compositions such as liquid crystal pigments, interference pigments, optically variable magnetic interference pigments and optically variable pigments based on photonic crystal materials may be employed and applied using any suitable method. Ink for the non-variable information may be applied using, for example, offset, flexo, gravure, intaglio, screen or letterpress printing methods. The variable or personalised information may be applied using, for example, inkjet, xerography, a transfer process, laser marking, laser perforation or laser engraving.

Finally, the protective layer 24 may be applied to the first surface 13 over the security deposit 18 and may comprise a laminate film or lacquer layer or any other suitable transparent or semi-transparent layer. A lacquer layer may be applied directly to the first layer 11 using heat and/or high pressure and a hot-melt adhesive, or via a transfer layer. The laminate film is preferably a non-self-supporting layer applied by a transfer process, but may also be a polymeric, self-supporting layer, applied to the first surface 13 using adhesive and/or heat sealing. In either process it is preferable to ensure that the adhesive and/or lacquer is pressed into the porous structure of the fibrous substrate at the first surface 13 to provide a thin, relatively stiff, region, for example extending into approximately 10% of the thickness of the first layer 11 from the first surface 13. This region not only provides added support to the first layer 11, but also assists in ensuring that the split plane 25 is within the first layer 11 as it will tend to be relatively close to the lacquer or adhesive pressed into the fibrous substrate.

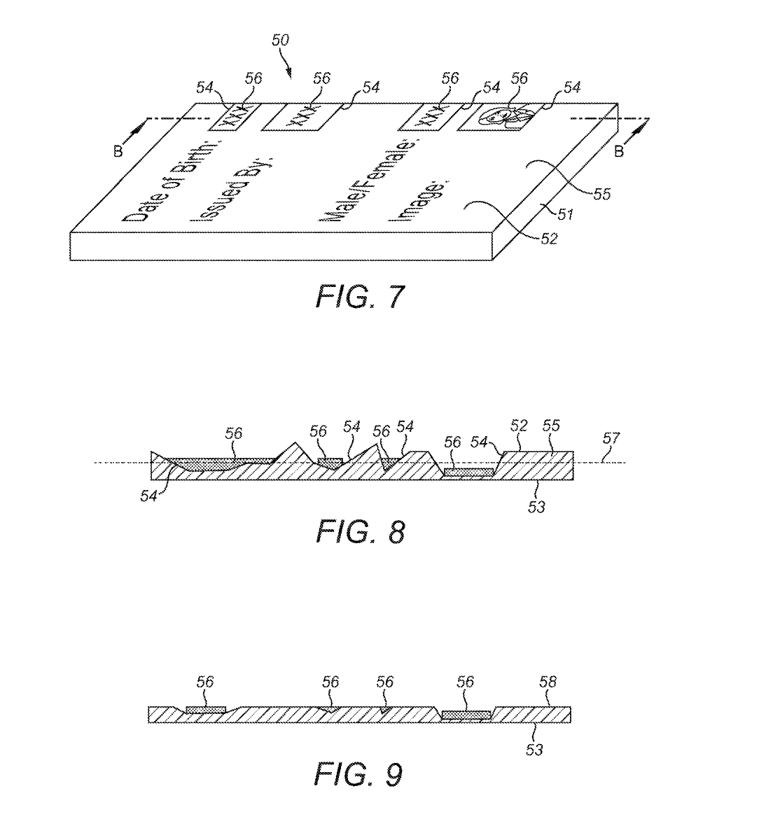

FIGS. 7 to 9 illustrates a second embodiment of the security paper 50 of the present invention which comprises a single layer 51 of fibrous substrate. This single layer 51 is produced in a similar manner to the first layer 11 of the first embodiment as described above and comprises first and second opposing outer surfaces 52, 53. The main difference in manufacture, as will be apparent to a person skilled in the art, is that a short former is not employed. All of the features described above in respect of the first layer 11 of the first embodiment are equally applicable to the single layer 51 of the second embodiment.

The layer 51 comprises zones 54 of reduced thickness provided by any one of the aforementioned controlled drainage zones 39, such as electrotype and/or cylinder mould watermarks. The layer 51 has a main body 55 of substantially uniform thickness except in the zones 54 of reduced thickness. The zones 54 preferably have a thickness of at least 15% less than the uniform thickness, and more preferably of at least 25% less than the uniform thickness. For example, the grammage of the uniform thickness may be approximately 90 gsm and the grammage of the zones 54 may be approximately 30 gsm.

Security deposit 56 is provided on the layer 51 at the first surface 52 and at least partially overlaps the zones 54 of reduced thickness in a similar manner to that discussed in respect of the first embodiment.

As the zones 54 are thin, when the security paper 50 is split along a split plane 57 into a first portion (not shown in FIG. 9) and a second portion 58, security deposit 56 remains on the second portion 58 such that it cannot be effectively reused. The counterfeiter would only be able to remove the parts of the security paper 50 above the split plane 57 which do not have a reduced thickness.

In a third embodiment of the present invention, the security paper 10, 50 is formed in the same manner as previously described in respect of the first and second embodiments and further comprises a region of security illuminate which is provided on the second surface 14, 53. The security illuminate is positioned on the second surface 14, 53 such that it at least partially overlaps one or more of the at least one zone 16 of reduced thickness and/or aperture 17. The region of the security illuminate may overlap with the entire zone 16 or aperture 17 (when viewed from the side of the second surface 14, 53) and may be in any suitable shape. The shape of the region may be arranged to be recognisable, such as being in the form of a square, circle, hexagon or the like, and may convey information, for example by being in the form of a word, symbol, logo or the like.

The security illuminate may or may not be visible to the human eye under standard illumination conditions, and could comprise a substance which is luminescent, fluorescent, phosphorescent, magnetically conductive, electrically conductive, photochromic and/or optically variable amplitude interference. The presence of the security illuminate may only be revealed by illumination at a non-visible wavelength such as ultraviolet light (i.e. having a wavelength of between approximately 40 nm and approximately 400 nm). The security illuminate could be identifiable both by a human viewer and by a machine.

The region of security illuminate is visible when illuminated and viewed in reflected light incident on the second surface 14, 53. It is also visible when illuminated and viewed in reflected light incident on the first surface 13, 52 through the zone 16 of reduced thickness and/or aperture 17 since the fibrous substrate in those regions is sufficiently thin. Such an arrangement further increases the security of the document since the presence of the region of security illuminate can be easily identified from the first surface 13, 52 when the security deposit 18, 56 is inspected.

The present invention is not restricted to the aforementioned embodiments. For example, the security paper could comprise a number of thin layers and the split plane could in fact be through the join of the layers. In a further embodiment the security paper may be multiple ply, in which the ply formed in the first and second embodiments is combined with a further ply of paper. Furthermore, the security document of the present invention is not restricted to passports and may instead be a certificate, identity card, cheque, travellers cheque, bond or the like.

What is claimed is:

1. A security paper comprising:
at least one layer of fibrous substrate having a main body of a uniform thickness and at least zone of a reduced thickness, the reduced thickness is non-zero and at least 15% less than the uniform thickness of the main body; and
a security deposit comprising at least one element that partially covers a surface of the at least one layer of fibrous substrate that is in the at least one zone such that, when the at least one layer is split through the uniform thickness into first and second portions, a hole is provided in the first portion and the at least one element remains on the at least one layer of fibrous substrate of the second portion.

2. The security paper as claimed in claim 1, wherein the at least one zone is an aperture.

3. The security paper as claimed in claim 1, wherein the reduced thickness is at least 25% less than the uniform thickness of the main body.

4. The security paper as claimed in claim 1, wherein the at least one element is separated from an edge of the at least one zone.

5. The security paper as claimed in claim 1, wherein the at least one element forms data that is visually recognisable to a user or is machine readable both before and after splitting the at least one layer of fibrous.

6. The security paper as claimed in claim 1, wherein the at least one zone is formed during the formation of the at least one layer of fibrous substrate from a fibrous stock using controlled drainage zones.

7. The security paper as claimed in claim 6, wherein the at least one layer of fibrous substrate is formed by a cylinder mould papermaking machine.

8. The security paper as claimed in claim 1, wherein the at least one element forms a shape, pattern and/or other indicia.

9. The security paper as claimed in claim 8, wherein the security deposit is visible to the naked eye or is machine readable.

10. The security paper as claimed in claim 1, further comprising a plurality of elements of the security deposit, wherein at least two elements of the plurality of elements are disposed within zones of reduced thickness.

11. The security paper as claimed in claim 1, wherein the security deposit is an ink.

12. The security paper as claimed in claim 1, wherein the at least one layer of fibrous substrate forms first and second surfaces of the security paper, the security deposit being located on the first surface and the security deposit which overlaps the at least one zone is visible in reflected light incident upon the second surface.

13. The security paper as claimed in claim 1, wherein the at least one layer of fibrous substrate comprises first and second layers of fibrous substrate, the at least one zone being formed in the first layer.

14. The security paper as claimed in claim 13, wherein:
the second layer is exposed in at least one aperture; and
the security deposit comprises at least one element which partially covers the second layer exposed in the at least one aperture such that, when the first and/or second layers are split into first and second portions, a hole is provided in the first portion and the at least one element is provided on the second layer in the second portion.

15. The security paper as claimed in claim 1, wherein:
the at least one layer of fibrous substrate forms first and second surfaces of the security paper;
the security deposit is located on the first surface; and
a security illuminate is provided on the second surface and overlaps the at least one zone, the security illuminate being visible through the at least one zone in reflected light incident upon the first surface.

16. A security document comprising the security paper of claim 1, wherein the security document is a document of value selected from the group consisting of a banknote, a cheque, a certificate, a passport, a passport page, an identification card, and a driver's licence.

17. A security document comprising the security paper of claim 1 and a transparent or semi-transparent protective layer provided over the at least one zone and the security deposit.

18. The security document as claimed in claim 17, wherein the protective layer is arranged such that when the at least one layer is split into the first and second portions, the hole is provided in the first portion through the protective layer and the security deposit and the protective layer are provided on the second portion.

19. The security document as claimed in claim 18, wherein the security document is a document of value selected from the group consisting of a banknote, a cheque, a certificate, a passport, a passport page, an identification card, and a driver's licence.

20. A security document comprising the security paper of claim 1, wherein the security deposit at least partially forms personalised information relating to an owner of the security document.

21. A method of manufacturing a security paper comprising the steps of:
depositing fibres from a vat of aqueous stock on a support surface to form a fibrous substrate and restricting drainage through the support surface at controlled drainage zones to form at least one layer of fibrous substrate having a main body of a uniform thickness and at least one zone of a reduced thickness, the reduced thickness being non-zero and at least 15% less than the uniform thickness of the main body;
couching the layer of fibrous substrate from the support surface;
drying the layer of fibrous substrate; and
providing a security deposit on the layer of fibrous substrate to at least partially overlap the at least one zone, such that when the at least one layer is split through the uniform thickness into first and second portions, a hole is provided in the first portion and the security deposit is provided on the second portion.

22. The method as claimed in claim 21, wherein the at least one zone comprises at least one aperture.

23. The method as claimed in claim 21, further comprising the step of, before the drying step, combining the layer of fibrous substrate with a second layer of fibrous substrate, the second layer of fibrous substrate being formed in a separate forming step.

24. The method as claimed in claim 21, wherein the controlled drainage zones are formed from at least one of a blinding material affixed to the support surface, an electrotype affixed to the support surface, and embossed regions in the support surface.

25. The method as claimed in claim 21, wherein the security deposit provision step further comprises:
identifying the at least one zone;
calculating a position of the at least one zone in the layer of fibrous substrate; and
depositing the security deposit in a predetermined position relative to the at least one aperture.

26. A method of manufacturing a security document comprising the method as claimed in claim 21 and the step of, after depositing the security deposit, applying a transparent or semi-transparent protective layer over the at least one zone and the security deposit.

27. The method as claimed in claim 26, wherein, during the application of the protective layer, the method comprises pressing an adhesive and/or lacquer into a region underneath a surface of the layer of fibrous substrate.
